(19) United States
(12) Patent Application Publication
(10) Pub. No.: US 2019/0324938 A1
(43) Pub. Date: Oct. 24, 2019

(54) METHOD FOR HOT-PLUGGING IDENTIFICATION AND SERVER WITH FUNCTION OF HOT-PLUGGING IDENTIFICATION

(71) Applicant: Wiwynn Corporation, New Taipei (TW)

(72) Inventors: Chung Fu HUANG, New Taipei (TW); Chia Ming TSAI, New Taipei (TW)

(21) Appl. No.: 16/128,722

(22) Filed: Sep. 12, 2018

(30) Foreign Application Priority Data
Apr. 18, 2018 (TW) 107113113

(51) Int. Cl. G06F 13/40; G06F 9/4401

(52) U.S. Cl. CPC G06F 13/4081; G06F 9/4401

(57) ABSTRACT

A method for hot-plugging identification adapted to a server, comprising the following steps: receiving a plurality of position messages and a plurality of codes by a microcontroller disposed on a backplane, with each of the plurality of position messages and each of the plurality of codes corresponding to a respective one of a plurality of hardware devices; generating a mapping table according to the plurality of position messages and the plurality of codes by the microcontroller, with the mapping table comprising a set of sequence information; delivering the set of sequence information to each of a plurality of central processors by the microcontroller; and identifying at least one of the plurality of hardware devices, to be controlled, by each of the plurality of central processors according to the set of sequence information.

### CROSS-REFERENCE TO RELATED APPLICATIONS

This non-provisional application claims priority under 35 U.S.C. § 119(a) on Patent Application No(s). 107113113 filed in Taiwan, R.O.C. on Apr. 18, 2018, the entire contents of which are hereby incorporated by reference.

### TECHNICAL FIELD

The disclosure relates to a method for hot-plugging identification and a sever with a function of hot-plugging identification, more particularly to a method for hot-plugging identification and a sever with a function of hot-plugging identification adapted to hardware devices.

### BACKGROUND

In general, a backplane of a storage server having several processors (CPUs) is provided for hardware devices to be plugged or unplugged. Since some types of hardware devices (e.g. PCIe SSD) do not support hot-plugging, a mechanism becomes necessary for delivering a message of plugging/unplugging those hardware devices to a respective one of processors in a storage server so as to complete a process of hot-plugging.

However, each of processors included in a storage server is responsible for controlling its individual hardware device(s). When one of the hardware devices is plugged into the storage server or unplugged from the storage server, there is no way to identify which one of the processors is responsible for controlling the plugged/unplugged hardware device. Due to the foregoing reasons, a backplane of the storage server is only allowed to be connected to a specific main board, therefore, the assembly of the storage server is restricted and inflexible. Accordingly, the burdens of designs and costs are increased.

### SUMMARY

A method for hot-plugging identification adapted to a server is disclosed according to one embodiment of the present disclosure. The method includes the following steps: receiving a plurality of position messages and a plurality of codes by a microcontroller disposed on a backplane. Each of the plurality of position messages and each of the plurality of codes correspond to a respective one of a plurality of hardware devices; generating a mapping table according to the plurality of position messages and the plurality of codes by the microcontroller. The mapping table includes a set of sequence information; delivering the set of sequence information to each of a plurality of central processors by the microcontroller; and identifying at least one of the plurality of hardware devices, to be controlled, by each of the plurality of central processors according to the set of sequence information. Each of the plurality of hardware devices is detachably connected to a respective one of a plurality of connecting port of the backplane, the set of sequence information includes the plurality of codes, and each of the plurality of central processors corresponds to at least one of the plurality of codes.

A server with a function of hot-plugging identification is disclosed according to one embodiment of the present disclosure. The server includes a backplane, a plurality of hardware devices, a microcontroller and a plurality of central processors. The backplane has a plurality of connecting port. Each of the plurality of hardware devices is detachably connected to a respective one of the plurality of connecting ports, wherein each of the plurality of hardware devices corresponds to a position message and a code. The microcontroller is disposed on the backplane and configured to generate a mapping table according to the plurality of position messages and the plurality of codes. The mapping table includes a set of sequence information. The plurality of central processors is electrically connected to the microcontroller, and each of the plurality of central processors is configured to identify at least one of the plurality of hardware devices to be respectively controlled. The set of sequence information includes the plurality of codes, and each of the plurality of central processors corresponds to at least one of the plurality of codes.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of a server with a function of hot-plugging identification according to one embodiment of the present disclosure;

FIG. 2 is a flow chart of a method for a hot-plugging identification according to one embodiment of the present disclosure;

FIG. 3 is a flow chart of a method for hot-plugging identification according to another embodiment of the present disclosure;

FIG. 4 is a partial flow chart of the method for hot-plugging identification according to one embodiment of the present disclosure; and

FIG. 5 is a block diagram of a server with a function of hot-plugging according another embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

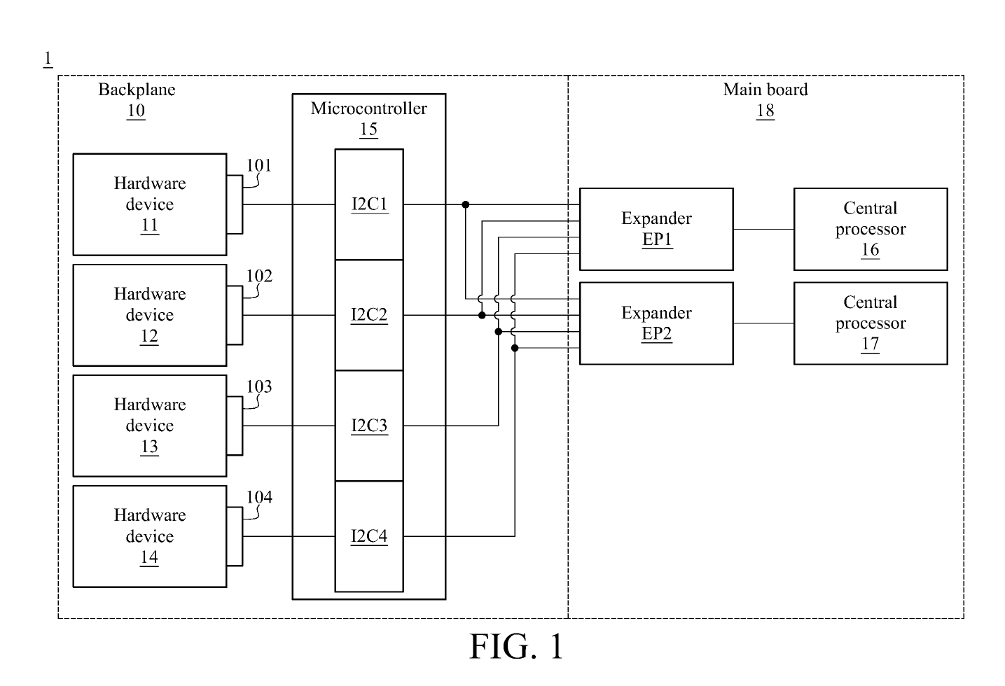

Please refer to FIG. 1, which is a block diagram of a server with a function of hot-plugging identification according to one embodiment of the present disclosure. As shown in FIG. 1, the server 1 includes a backplane 10, a plurality of hardware devices 11-14, a microcontroller 15 and a plurality of central processors 16 and 17. The backplane 10 has a plurality of connecting ports 101-104. Each of the hardware devices is detachably connected to a respective one of the connecting ports. For example, FIG. 1 shows that the hardware devices 11-14 are detachably connected to the connecting ports 101-104 respectively. The microcontroller 15 is disposed on the backplane 10. In practice, the server 1 further includes a main board 18 adapted to be connected to the backplane 10. Both of the central processors 16 and 17 are disposed on the main board 18 and electrically connected to the microcontroller 15. In practice, the microcontroller 15 is, for example, a Complex Programmable Logic Device (CPLD) or other device with functions of logical computations. In an example, each of the hardware devices 11-14 is one of PCIe SSD, NVMe SSD or edsff SSD, but the present disclosure is not limited to the above example.

In this embodiment, each of the hardware devices has a respective position message and a code. The microcontroller 15 is configured to generate a mapping table according to the position messages and the codes. For example, the hardware device 11 corresponds to the position message SN1 and the code “1”, the hardware device 12 corresponds to the position message SN2 and the code “0”, the hardware device 13 corresponds to the position message SN3 and the code “1” and the hardware device 14 corresponds to the position message SN4 and the code “1”. The microcontroller 15 is capable of generating the mapping table (namely “Table I” shown below) according to the position messages and the codes. The mapping table includes a set of sequence information SE including the codes “1011”. Each of the central processors is configured to identify at least one hardware device of the hardware devices 11-14 according to the set of sequence information SE (namely “1011”), with the at least one hardware device to be controlled by either the central processor 16 or the central processor 17. In this embodiment, each of the central processors corresponds to at least one of those codes.

TABLE I

| Position message | Code |
|---|---|
| SN1 | 1 |
| SN2 | 0 |
| SN3 | 1 |
| SN4 | 1 |

Specifically, in an initial state, each of the central processors is defined to be corresponding to a code in advance. For example, the central processor 16 is defined to be corresponding to a code “1” in advance, and the central processor 17 is defined to be corresponding to a code “0” in advance. Further, the codes (“1” or “0”) are respectively assigned to the hardware devices. In this embodiment, the code “1” is assigned to the hardware devices 11, 13 and 14 corresponding to the position messages SN1, SN3 and SN4 respectively. The code “0” is assigned to the hardware device 12 corresponding to the position message SN2. When the server is started, each of the hardware devices notifies the microcontroller 15 of its own position message and code by its respective connecting port through a respective GPIO pin (Not shown in figures). For example, the hardware device 11 notifies the microcontroller 15 of its own position message SN1 and the code “1” by the connecting port 101 through a respective GPIO pin, the hardware device 12 notifies the microcontroller 15 of its own position message SN2 and the code “0” by the connecting port 102 through a respective GPIO pin, the hardware device 13 notifies the microcontroller 15 of it own position message SN3 and the code “1” by the connecting port 103 through a respective GPIO pin, and the hardware device 14 notifies the microcontroller 15 of it own position message SN4 and the code “1” by the connecting port 104 through a respective GPIO pin.

The microcontroller 15 generates the mapping table (namely “Table I”) according to the position messages and the codes coming from the connecting ports. Further, the microcontroller 15 sends information regarding the mapping table to both of the central processors 16 and 17 through buses I2C1-I2C4. In other words, the central processors 16 and 17 both receive the set of sequence information SE (namely “1011”). Since the central processor 16 is defined to be corresponding to the code “1” in advance, the central processor 16 can determine that the central processor 16 itself is responsible for controlling the hardware devices 11, 13 and 14 connected to the connecting ports 101, 103 and 104 respectively according to the set of sequence information SE including the codes “1011” as receiving the set of sequence information SE. Since the central processor 17 is defined to be corresponding to the code “0” in advance, the central processor 17 can determine that the central processor 17 itself is responsible for controlling the hardware device 12 connected to the connecting port 102 according to the set of sequence information SE including the codes “1011” as receiving the set of sequence information SE.

In an embodiment, when one of the hardware devices 11-14 is removed from the respective connecting port, the microcontroller 15 is configured to drive one of the central processors 16 and 17 to generate a reset signal according to a status signal related to the removed hardware device. For example, when the hardware device 12 is removed from the respective connecting port 102, the connecting port 102 accordingly sends out a status signal to the microcontroller 15. The microcontroller 15 further notifies the central processor 17 that the hardware device 12 is removed from the respective connecting port 102. Further, the central processor 17 generates a reset signal accordingly, so that the connecting port 102, corresponding to the removed hardware device 12, adjust its own current potential. Specifically, when the hardware device 12 is connected to the respective connecting port 102, the current potential of the connecting port 102 remains in a high-state. When the hardware device 12 is removed from the respective connecting port 10, the reset signal generated by the central processor 17 is used for converting the current potential from the high-state to a low-state, so that a hot-plugging process is completed.

In an example, the microcontroller 15 is configured to checking the mapping table according to the status signal related to the removed hardware device so as to identify the central processors 16 and 17, so that the identified central processor generates the reset signal. In an example, when the hardware device 12 is removed from the respective connecting port 102, since the status signal is sent by the connecting port 102, the microcontroller 15 is capable of checking the mapping table (Table I) according to position message SN2 serving as a source of the status signal to identify that the hardware device 12 connected to the connecting port 102 is controlled by the central processor 17. In practice, as shown in FIG. 1, the server with the function of hot-plugging identification further includes a plurality of expanders EP1 and EP2 which are electrically connected to the central processors 16 and 17 respectively and the microcontroller 15. In one embodiment, when the central processor 17 generates the reset signal, the central processor 17 sends the reset signal to the connecting port 102 corresponding to the removed hardware device 12 through the respective expander EP2. The purpose of the present disclosure is that, by using the set of sequence information formed by the codes which are defined to be corresponding to the hardware devices in advance, each of the central processors is capable of identifying the one or more hardware devices to be controlled. Therefore, when a hot-plugging process is performed within the server, each of the central processors is capable of determining whether or not the plugged/removed hardware device is controlled by itself. By taking the advantage of the present disclosure, the backplane is not limited to be connected to a specific main board, so that convenience of a server assembly is raised and the burdens of designing and costing are reduced accordingly.

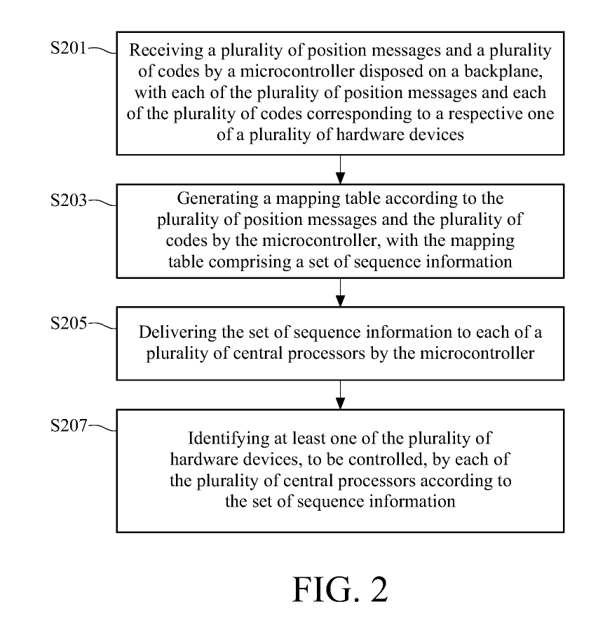

Please refer to FIG. 2, which is a flow chart of a method for a hot-plugging identification according to one embodiment of the present disclosure. The method is adapted to the server 1 shown in FIG. 1. As shown in FIG. 1 and FIG. 2, in step S201, the microcontroller 15, disposed on the backplane, receives a plurality of position messages and a plurality of codes, with each of the position messages and each of the codes corresponding to a respective one of the hardware devices 101-104. In step S203, the microcontroller 15 generates a mapping table (e.g. Table I) including the set of sequence information SE according to the position messages SN1-SN4 and the codes.

In step S205, the microcontroller 15 sends the set of sequence information to both of the central processors 16 and 17. For example, the central processor 16 and the central processor 17 both receive the set of sequence information SE (namely “1011”). In step S207, each of the central processors identifies at least one of hardware devices 11-14, to be controlled, according to the set of sequence information. Specifically, the set of sequence information SE consists of code “0” or “1”. Either the code “0” or the code “1” is assigned to each of the connecting ports corresponding to the hardware devices. By analyzing the set of sequence information SE including the codes, each of the central processor 16 and the central processor 17 is capable of identifying the hardware device(s) to be controlled.

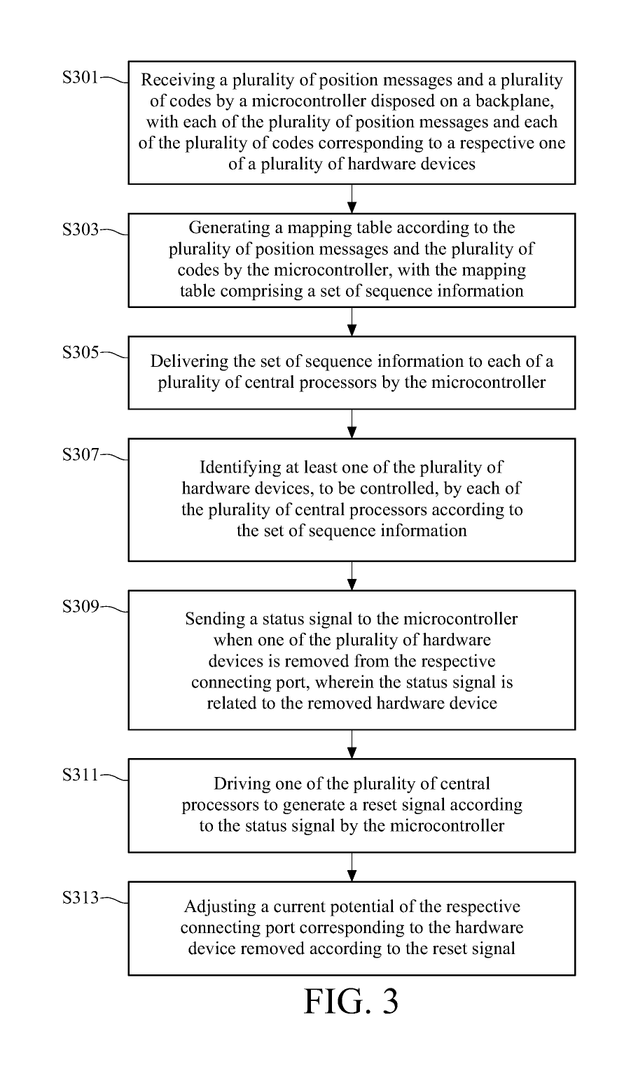

Please further refer to FIG. 3, which is a flow chart of a method for hot-plugging identification according to another embodiment of the present disclosure. As shown in FIG. 3, steps S301-S307 are similar to steps S201-S207. Comparing to the embodiment of FIG. 2, the embodiment of FIG. 3 further includes steps S309-S313. In step S309, when one of the hardware devices 11-14 is removed from a respective connecting port, a status signal related to the removed hardware device is sent to the microcontroller 15. In step S311, the microcontroller drives one of the central processors 16 and 17 to generate a reset signal according to the status signal. In step S313, the connecting port, corresponding to the removed hardware device, adjusts a current potential according the reset signal. In one embodiment, the method for hot-plugging identification further includes a step that the reset signal is sent to the connecting port corresponding to the removed hardware device by a respective one of a plurality of expanders. In the embodiment of FIG. 1, when the hardware device 12 is removed, the reset signal generated by the central processor 17 is sent to the connecting port 102 by the expander EP2.

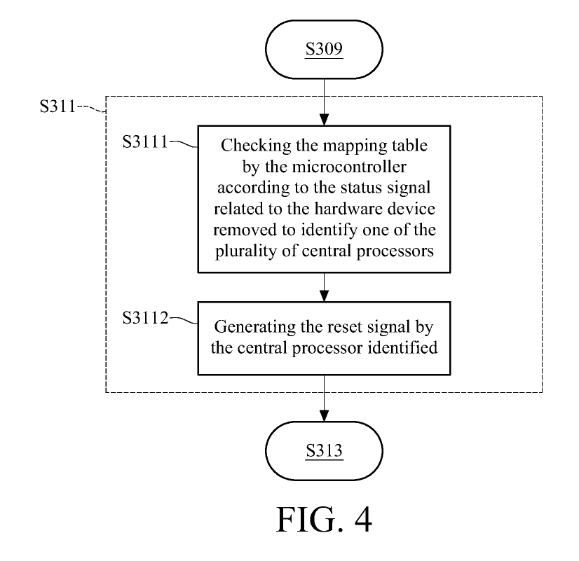

Please further refer to FIG. 4, which is a partial flow chart of the method for hot-plugging identification according to one embodiment of the present disclosure. The embodiment of FIG. 4 is similar to the embodiment of FIG. 3. Comparing to the embodiment of FIG. 3, step S311 shown in the embodiment of FIG. 4 includes steps S3111 and S3112. In steps S3111, the microcontroller checks the mapping table according to the status signal related to the removed hardware device to identify the central processors. In step S3112, the identified central processor generates the reset signal. Specifically, when the hardware device 12 is removed from the respective connecting port 102, the respective connecting port 102 sends the status signal out. The microcontroller 15 further checks the mapping table (e.g. Table I) to identify that the hardware device 12 connected to the connecting port 102 is controlled by the central processor 17 according to the position message SN2 serving as a source of the status signal. Further, the microcontroller 15 drives the central processor 17 to generate the reset signal and sends the reset signal back to the connecting port 102 via the buses, so as to pull low the current potential to complete the process of hot-plugging.

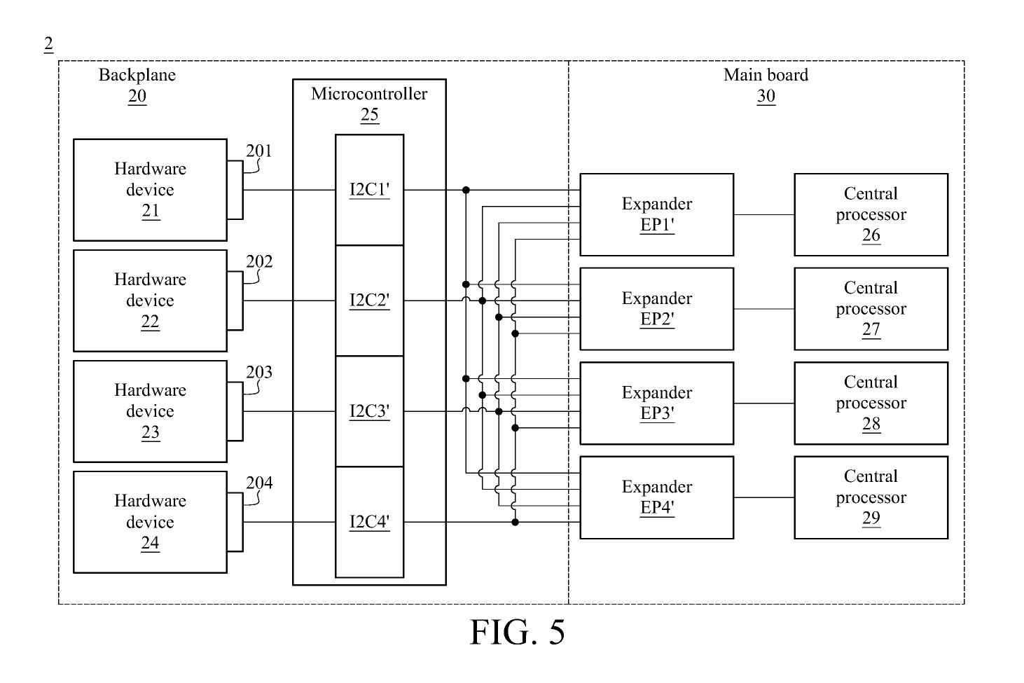

Please refer to FIG. 5, which is a block diagram of a server with a function of hot-plugging according another embodiment of the present disclosure. An illustration regarding a server with two central processors is given in the embodiment of FIG. 1. Different from the embodiment of FIG. 1, an illustration regarding a server with four central processors is given in the embodiment of FIG. 5. Similar to the structure of FIG. 1, a server 2 with a function of hot-plugging includes a backplane 20, a plurality of hardware devices 21-24, a microcontroller 25 and a plurality of central processors 26-29. The backplane 20 has a plurality of connecting ports 201-204. The hardware devices 21-24 are detachably connected to the connecting ports 201-204 respectively. The server 2 further has a main board 30 adapted to be connected to the backplane 20 and provided for the central processors 26-29 to be disposed. The server 2 further has expanders EP1′-EP4′ electrically connected to the central processors 26-29 respectively and the microcontroller 25. Similarly, in one example, the microcontroller 25 is a Complex Programmable Logic Device (CPLD) or other devices with functions of computation. Each of the hardware devices 21-24 is one of PCIe SSD, NVMe SSD or edsff SSD, but the present disclosure is not limited to the above example.

In this embodiment, each of the hardware devices has a respective position message and a respective code. The microcontroller 25 is configured to generates a mapping table according to the position messages and the codes. For example, the hardware device 21 corresponds to a position message SN1′ and a code “00”, the hardware device 22 corresponds to a position message SN2′ and a code “01”, the hardware device 23 corresponds to a position message SN3′ and a code “10” and the hardware device 24 corresponds to a position message SN4′ and a code “11”. The microcontroller 25 generates a mapping table (namely “Table II”) according to the position messages and the codes. The mapping table includes a set of sequence information SE′ including the codes “00011011”. Each of the central processors is configured to identify at least one hardware device to be controlled among the hardware devices 21-24 according to the set of sequence information SE′ (namely “00011011”). In this embodiment, each of the central processors corresponds to at least one of those codes.

TABLE II

| Position message | Code |
|---|---|
| SN1′ | 00 |
| SN2′ | 01 |
| SN3′ | 10 |
| SN3′ | 11 |

Specifically, similar to the embodiment of FIG. 1, in an initial state, the central processors 26, 27, 28 and 29 are defined to be corresponding to codes “00”, “01, 10, 11 respectively. When the server is started, each of the hardware devices 21-24 notifies the microcontroller 25 of its own position message and code by its respective connecting port through a respective GPIO pin. In other words, the hardware device 21 notifies the microcontroller 25 of it own position message SN1′ and code “00” by the connecting port 201 through a respective GPIO pin, the hardware device 22 notifies the microcontroller 25 of its own position message SN2′ and code “01” by the connecting port 202 through a respective GPIO pin, the hardware device 23 notifies the microcontroller 25 of its own position message SN3′ and code “10” by the connecting port 203 through a respective GPIO pin, and the hardware device 24 notifies the microcontroller 25 of its own position message SN4′ and code “11” by the connecting port 204 through a respective GPIO pin. Further, the microcontroller 25 generates the mapping table (namely “Table II”) according the position messages and the codes from the connecting ports. The microcontroller 15 sends information regarding the mapping table to the central processors 26-29 through buses I2C1′-I2C4′ respectively. In other words, each of the central processors 26-29 receives the set of sequence information SE′(namely “00011011”). As described above, the central processors 26-29 are defined to be corresponding to the code “00”, the code “01”, the code “10” and the code “11” respectively in advance. Therefore, when each of the central processors 26-29 receives the set of sequence information SE′, the central processors 26-29 are capable of identifying that the hardware devices 21-24 to be controlled respectively according to the set of sequence information SE′ including the codes “00011011”. Similarly, in this embodiment, when one of the hardware devices is removed from its respective connecting port, the central processor responsible for controlling the removed hardware device will generate a reset signal adapted to pull low a current potential of the connecting port, so as to complete a hot-plugging process. Since the operation of this embodiment is similar to the operation of the aforementioned embodiment, detailed illustration regarding this embodiment is not repeated here.

Different from the embodiment of FIG. 1, the server 2 has four central processors in the embodiment of FIG. 5. In order to let each of the four central processors has a respective code, the usage of two-bit codes becomes necessary to generate the four codes which are 00, 01, 10, 11. Thereby, each of the central processors is capable of identifying the hardware device to be controlled among the plurality of hardware devices according to the information indicated in Table II. However, the present disclosure is not limited to the embodiments of FIG. 1 and FIG. 5. In an implementation, according to the technical contents of the embodiments of FIG. 1 and FIG. 5, persons having ordinary skills in the art are able to design another mechanism of hot-plugging identification with the usages of other types of codes higher than the two-bit codes so as to perform a hot-plugging identification in a server with more central processors. For example, three-bit codes (e.g. 000, 001, 010, 011 . . . 111) may be used for providing a respective code to each of the eight central processors in a server so as to perform a hot-plugging identification in the server.

Based on the above description, in the method for hot-plugging identification and the server with the function of hot-plugging identification, by using the set of sequence information including a plurality of codes each corresponding to a respective one of hardware devices, each of central processor is capable of determining the hardware device to be controlled so as to complete the hot-plugging process. Thereby, a backplane is not limited to be connected to a specific main board. In contrary, the backplane is allowed to be connected to any type of main board. Therefore, the convenience of assembly of a server is raised and the burdens of designing and costing are reduced.

What is claimed is:

1. A method for hot-plugging identification, adapted to a server, comprising:
receiving a plurality of position and a plurality of codes by a microcontroller disposed on a backplane, with each of the plurality of position messages and each of the plurality of codes corresponding to a respective one of a plurality of hardware devices;
generating a mapping table according to the plurality of position messages and the plurality of codes by the microcontroller, with the mapping table comprising a set of sequence information;
delivering the set of sequence information to each of a plurality of central processors by the microcontroller; and
identifying at least one of the plurality of hardware devices, to be controlled, by each of the plurality of central processors according to the set of sequence information;
wherein each of the plurality of hardware devices is detachably connected to a respective one of a plurality of connecting port of the backplane, the set of sequence information comprises the plurality of codes, and each of the plurality of central processors corresponds to at least one of the plurality of codes.

2. The method for hot-plugging identification according to claim 1, further comprising:
sending a status signal to the microcontroller when one of the plurality of hardware devices is removed from the respective connecting port, wherein the status signal is related to the removed hardware device;
driving one of the plurality of central processors to generate a reset signal according to the status signal by the microcontroller; and
adjusting a current potential of the respective connecting port corresponding to the hardware device removed according to the reset signal.

3. The method for hot-plugging identification according to claim 2, wherein driving one of the plurality of central processors to generate the reset signal according to the status signal by the microcontroller comprises:
checking the mapping table by the microcontroller according to the status signal related to the hardware device removed to identify one of the plurality of central processors; and
generating the reset signal by the central processor identified.

4. The method for hot-plugging identification according to claim 2, further comprising:
sending the reset signal to the respective connecting port corresponding to the hardware device removed by a respective one of a plurality of expanders.

5. A server with a function of hot-plugging identification, comprising:
a backplane having a plurality of connecting port;
a plurality of hardware devices, with each of the plurality of hardware devices detachably connected to a respective one of the plurality of connecting ports, wherein each of the plurality of hardware devices corresponds to a position message and a code;
a microcontroller disposed on the backplane and configured to generate a mapping table according to the plurality of position messages and the plurality of codes, with the mapping table comprising a set of sequence information; and
a plurality of central processors electrically connected to the microcontroller, with each of the plurality of central processors configured to identify at least one of the plurality of hardware devices to be respectively controlled;
wherein the set of sequence information comprises the plurality of codes, and each of the plurality of central processors corresponds to at least one of the plurality of codes.

6. The server with the function of hot-plugging identification according to claim 5, wherein when one of the plurality of hardware devices is removed from the respective connecting port, the microcontroller is further configured to drive one of the plurality of central processors to generate a reset signal according to a status signal related to the removed hardware device, and the connecting port, corresponding to the hardware device removed, is configured to adjust a current potential according to the reset signal.

7. The server with the function of hot-plugging identification according to claim 6, wherein the microcontroller is configured to identify one of the plurality of central processors by checking the mapping table according to the status signal related to the hardware device removed, so that the central processor, identified by the microcontroller, generates the reset signal.

8. The server with the function of hot-plugging identification according to claim 6, further comprising:
a plurality of expanders, with each of the plurality of expanders electrically connected to a respective one of the plurality of central processors and the microcontroller, the reset signal being sent to the respective connecting port, corresponding to the hardware device removed, through a respective one of the plurality of expanders.
